(19) United States
(12) Patent Application Publication
(10) Pub. No.: US 2018/0246142 A1
(43) Pub. Date: Aug. 30, 2018

(54) SYSTEMS AND METHODS FOR RECALIBRATING A MEASUREMENT INSTRUMENT

(71) Applicant: West Energy Support & Technology, Inc., Loveland, CO (US)

(72) Inventor: James Glover, Kildeer, IL (US)

(21) Appl. No.: 15/903,168

(22) Filed: Feb. 23, 2018

Related U.S. Application Data
(60) Provisional application No. 62/463,026, filed on Feb. 24, 2017.

(51) Int. Cl. G01P 21/00; G01D 3/06

(52) U.S. Cl. CPC G01P 21/00; G01D 3/063

(57) ABSTRACT

Systems and methods are provided for recalibrating a measurement instrument that includes a transducer coupled to a signal conditioning module. During an initial calibration of the measurement instrument, a transducer signal is recorded and stored to a non-transitory storage medium. During recalibration, the transducer is electrically disconnected from the signal conditioning module, and the recorded transducer signal is retrieved from the non-transitory storage medium and injected into the signal conditioning module to generate a measurement output. The measurement output may then be compared with a calibrated measurement to determine if the measurement instrument is out of calibration.

### CROSS-REFERENCE TO RELATED APPLICATION

This application claims priority to U.S. Provisional Patent Application Ser. No. 62/463,026, titled “Technique for Periodic Recalibration of Measurement Instrumentation,” and filed on Feb. 24, 2017, the entirety of which is incorporated herein by reference.

### TECHNICAL FIELD

The technology described herein relates generally to measurement instruments recalibration.

### BACKGROUND

The periodic recalibration of a measurement instrument, such as a flow meter, typically requires the instrument to be removed from the system in which it is being used and sent to a recalibration facility for comparison against a certified measurement standard. This process is often costly both in terms of the price for recalibration services and the time that the instrument is out of service while out for recalibration.

### SUMMARY

Systems and methods are provided for recalibrating a measurement instrument that includes a transducer coupled to a signal conditioning module. During an initial calibration of the measurement instrument, a transducer signal is recorded and stored to a non-transitory storage medium. During recalibration, the transducer is electrically disconnected from the signal conditioning module, and the recorded transducer signal is retrieved from the non-transitory storage medium and injected into the signal conditioning module to generate a measurement output. The measurement output may then be compared with a calibrated measurement to determine if the measurement instrument is out of calibration.

A device for recalibrating a measurement instrument may include a processor configured to retrieve a recorded transducer signal from a non-transitory storage medium, wherein the recorded transducer signal is stored to the non-transitory storage medium during an initial calibration of the measurement instrument. The device may further include an output port configured to be coupled to the input port of a signal conditioning module of the measurement instrument in place of a transducer. The processor may be further configured to cause the recorded transducer signal to be injected from the output port into the signal conditioning module, whereby the recorded transducer signal causes the signal conditioning module to generate a measurement output for use in recalibrating the measurement instrument with reference to a calibrated measurement.

### BRIEF DESCRIPTION OF THE FIGURES

FIG. 1 is a diagram of an example measurement instrument.

FIG. 2 is a diagram illustrating an example recalibration device for recalibrating the measurement instrument shown in FIG. 1.

FIGS. 3 and 4 are block diagrams illustrating an example system and method for recalibrating a measurement instrument.

FIGS. 5 and 6 are block diagrams showing another example of a system for recalibrating a measurement instrument.

FIGS. 7 and 8 are block diagrams showing an additional example of a system for recalibrating a measurement instrument.

FIG. 9 is a flow diagram of an example method for recalibrating a measurement instrument.

FIGS. 10-12 illustrate additional examples of a recalibration device for recalibrating a measurement instrument.

### DETAILED DESCRIPTION

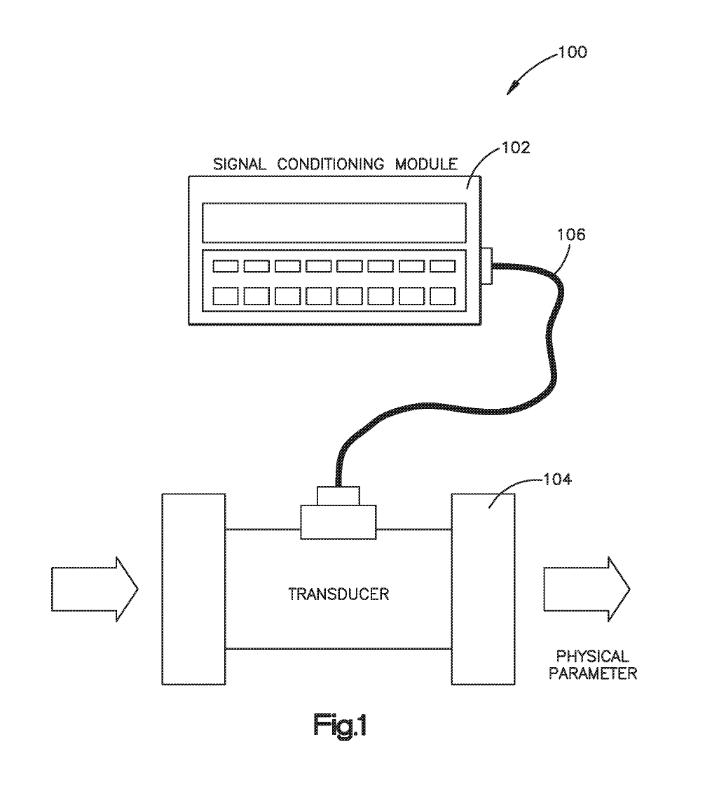

FIG. 1 is a diagram of an example measurement instrument 100 that may be recalibrated using the systems and methods described herein. The example measurement instrument 100 includes a signal conditioning module 102 that is coupled to a transducer 104. The transducer 104 receives a physical stimulus and generates a transducer signal in response to one or more physical parameters of the stimulus. For instance, in one example the transducer 104 may be a flow transducer that generates a transducer signal that is proportional to the flow velocity of a liquid or gas flowing through the transducer. In other examples, the transducer 104 may be responsive to other physical parameters, such as pressure, temperature, etc.

The signal conditioning module 102 receives the transducer signal through an electrical connection 106 to the transducer 104. The electrical connection 106 may, for example, be any suitable type of connector, assembly, or circuitry that enables the transducer 104 to be electrically disconnected from and reconnected to the signal conditioning module 102. The signal conditioning module 102 converts the transducer signal into a format that may be displayed or otherwise processed by the measurement instrument. For instance, an example signal conditioning module 102 may include amplification, analog-to-digital conversion and/or other circuitry suitable for converting the transducer signal into a desirable format for display or further processing. In certain examples, the signal conditioning module 102 may include a digital or analog display for displaying a measurement output.

In different examples, the measurement instrument 100 illustrated in FIG. 1 may be a vortex flow meter, a magnetic flow meter, a CiDRA passive flow meter, an ultrasonic flow meter, a temperature transmitter with one or more well quantified transducers, or other type of measurement instrument with one or more discrete transducers. In embodiments, the measurement instrument 100 includes one or more transducers 104 that either do not have a degradation mechanism that would affect the accuracy of the measurement, or that have a statistically quantified degradation mechanism which may affect the accuracy of the measurement but can be accounted for with a known amount of uncertainty during recalibration.

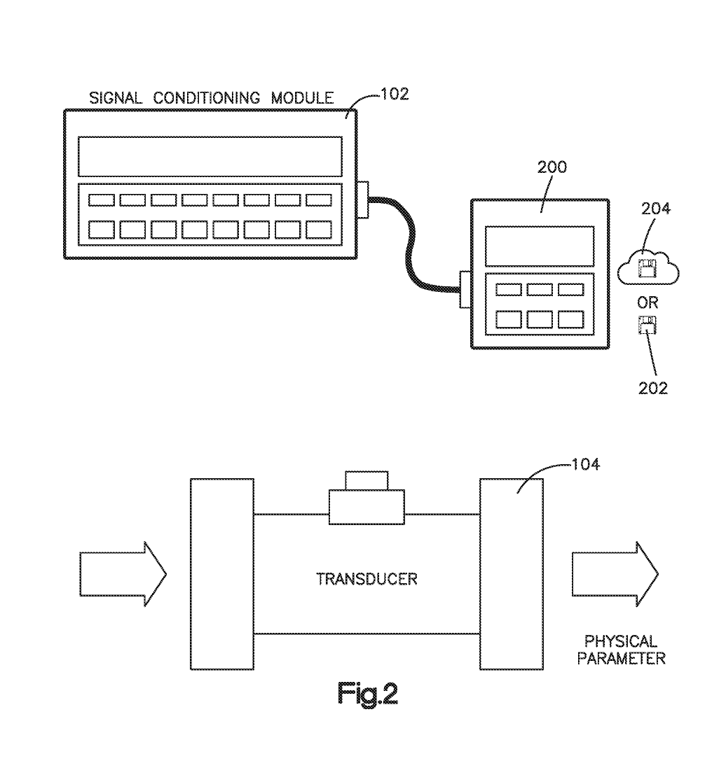

FIG. 2 is a diagram illustrating an example recalibration device 200 for recalibrating the measurement instrument 100 shown in FIG. 1. As shown, to utilize the recalibration device 200, the transducer 104 is electrically disconnected from an input port of the signal conditioning module 102, and an output port of the recalibration device 200 is electrically connected to the input port of the signal conditioning module 102 in place of the transducer 104. For instance, in one example, a wire assembly connecting the signal conditioning module 102 to the transducer 104 may be disconnected from the transducer 104 and reconnected to the recalibration device 200.

In operation, the recalibration device 200 is used to inject one or more stored transducer signals into the signal conditioning module 102. The measurement(s) resulting from injection of the one or more stored transducer signals into the signal conditioning module 102 is then compared against one or more calibrated measurements to determine if the measurement instrument 102, 104 is out of calibration. If out of calibration, the measurement instrument may be adjusted accordingly, and the process repeated until the measurement(s) resulting from injection of the one or more stored transducer signals match the calibrated measurement(s). For instance, in some examples the measurement(s) resulting from injection of the one or more stored transducer signals may be used to calculate one or more correction constants that are used to adjust the signal conditioning module.

In embodiments, the one or more stored transducer signals used during the recalibration process may be recorded during an initial calibration of the measurement instrument 100. For instance, prior to being sold or deployed into the field, the measurement instrument 100 may be subject to a standard calibration procedure in which the measurement instrument 100 is subjected to a range of physical parameters and the resultant measurements are compared against and calibrated to a certified calibration standard(s). During this initial calibration procedure, the transducer signal(s) generated by the measurement instrument 100 may be recorded and stored with reference to the corresponding measurement(s) from the certified calibration standard(s).

As illustrated in FIG. 2, the stored transducer signal(s) from the initial calibration procedure may, for example, be stored to a local storage medium 202 and loaded into the memory of a recalibration device 200 or may be stored in a network storage medium 204 (such as cloud storage) and loaded to the recalibration device 200 via a wired or wireless network connection. The recalibration device 200 may then use the stored transducer signal(s) for recalibration by injecting the stored transducer signal(s) into the signal conditioning module 102 and comparing the resultant measurement(s) against the corresponding stored measurement(s) from the certified calibration standard(s).

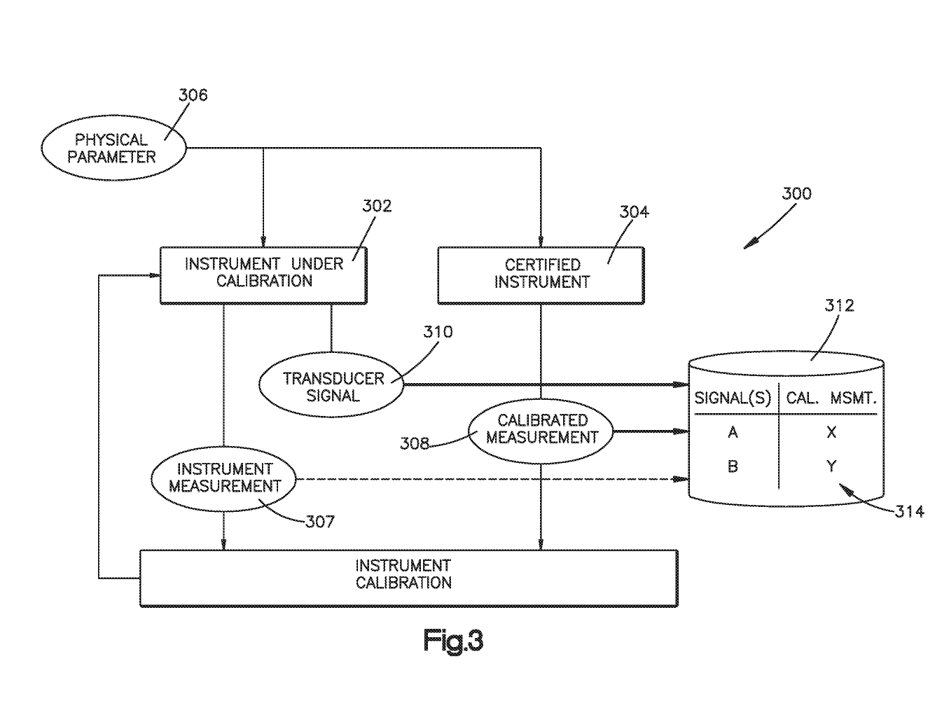

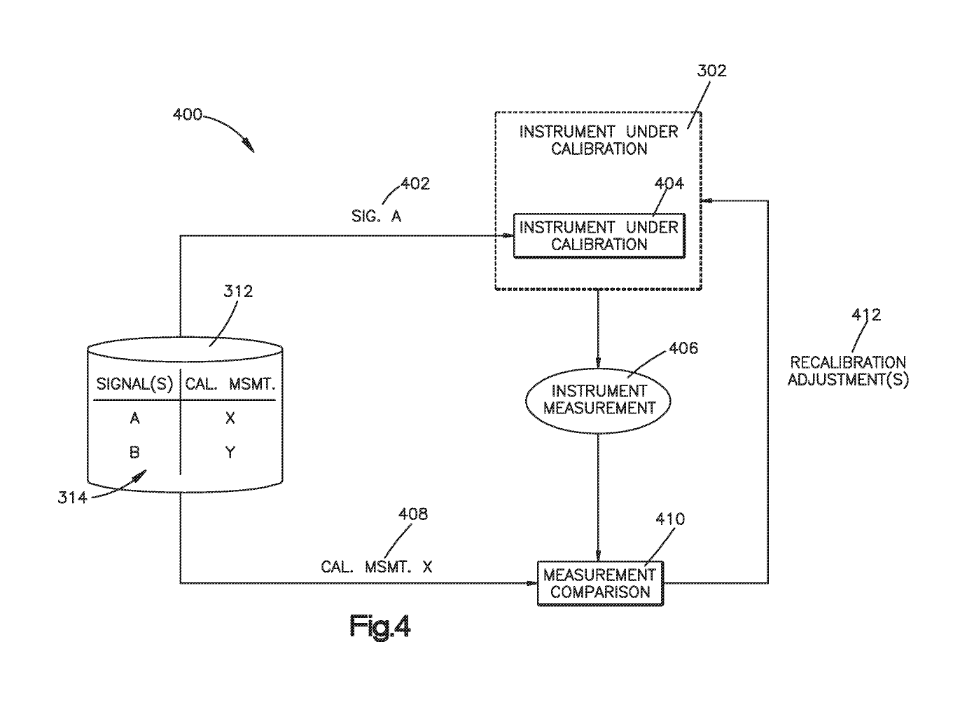

FIGS. 3 and 4 are block diagrams illustrating an example system and method for recalibrating a measurement instrument. More specifically, FIG. 3 illustrates an example system and method 300 for storing calibration data during an initial calibration of the measurement instrument, and FIG. 4 illustrates an example system and method 400 for using the stored calibration data for recalibrating the measurement instrument.

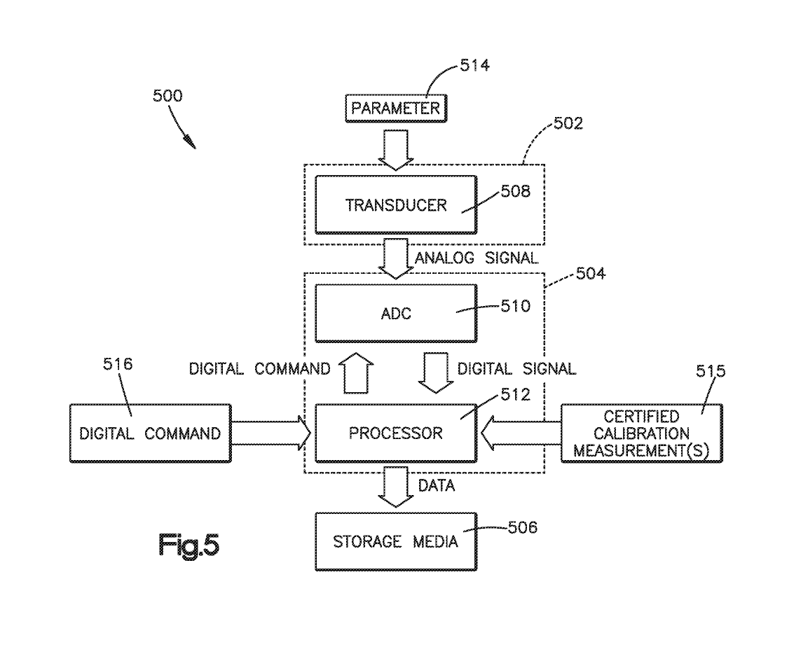

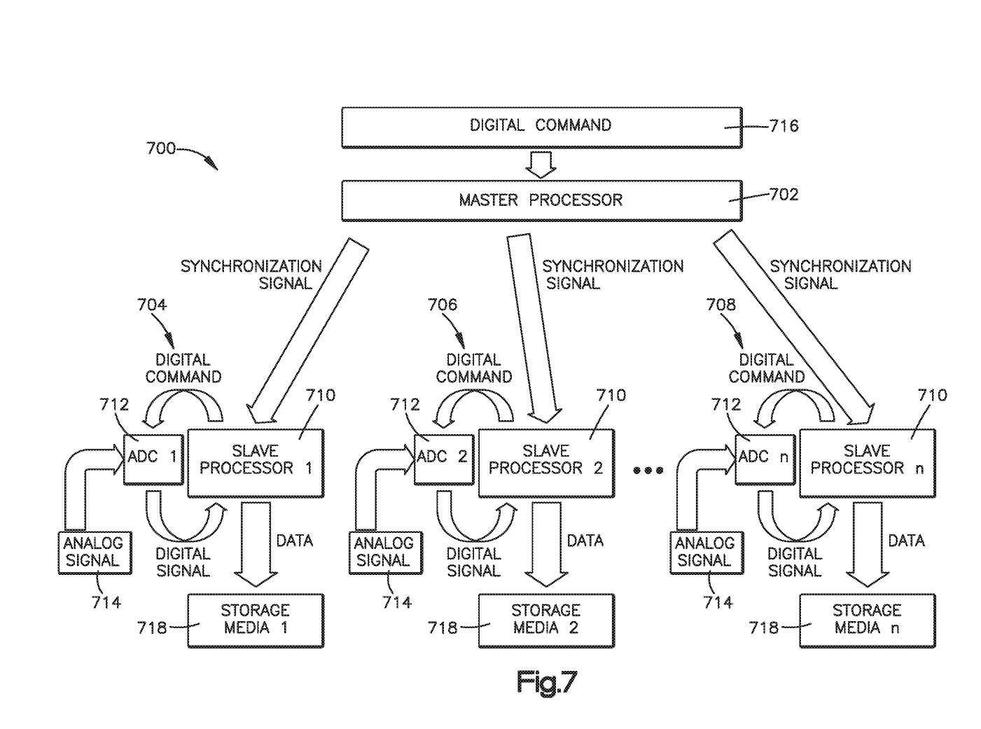

With reference first to FIG. 3, the illustrated example 300 shows the initial calibration of a measurement instrument 302 using a certified calibration standard 304 (i.e., another measurement instrument that has been certified to be calibrated to the applicable standard(s)). During the initial calibration, both measurement instruments 302, 304 are subjected to one or more physical parameters 306 that the instruments are designed to measure. The resultant measurements 307, 308 are compared and used for calibration of the measurement instrument 302 in the standard fashion. During this calibration process, the transducer signal(s) 310 generated by the instrument under calibration 302 is recorded and stored to a storage device 312. In addition, calibrated measurement(s) 308 from the certified calibration standard 304 are also stored in the storage device 312 in relation to the corresponding transducer signal(s) 310. For instance, in one embodiment, the recorded transducer signal(s) 310 and calibrated measurement(s) 308 may be related in a stored data structure 314 by storing the data 308, 310 along with a corresponding time stamp(s), such that the transducer signal(s) 310 is matched with a calibrated measurement(s) 308 from the same instant in time. In embodiments, the transducer signal(s) 310 and calibrated measurement(s) 308 may be stored using a recording device or system, for example as described below with reference to FIGS. 5 and 7.

The illustrated example 300 shows a stored calibration data file having a data structure 314 that includes two recorded transducer signals (A and B) and two corresponding calibrated measurements (X and Y). It should be understood, however, that other examples could include more or fewer recorded signals and corresponding calibrated measurements. In addition, other examples may include measurement instruments 302, 304 that generate measurements 307, 308 in response to more than one transducer signal, and thus the stored calibration data file 314 may include calibrated measurements that correspond to two or more recorded transducer signals. In addition, in alternative embodiments, the stored calibrated measurement may be obtained from the measurement 307 of the instrument under calibration 302 (illustrated by the dotted arrow in FIG. 3), or the measurement 307 may be stored in the storage medium 312 along with the calibrated measurement 308 for comparison or other purposes during recalibration.

With reference now to FIG. 4, the illustrated example 400 shows the stored calibrated data file 314, which was captured during initial calibration, being used to recalibrate the measurement instrument 302 after it has been deployed in the field. During recalibration 400, the recorded transducer signal(s) 402 stored in the data file 314 is injected into the signal conditioning module 404 of the measurement instrument 302 to generate an instrument measurement output 406. The stored calibration measurement 408 corresponding to the injected transducer signal 402 is then compared 410 to the instrument measurement output 406 to determine if the measurement instrument 302 is out of calibration. If out of calibration, appropriate calibration adjustments 412 are made to the measurement instrument 302 until the instrument measurement 406 matches the calibrated measurement 408. For example, in certain embodiments, a difference between the stored calibration measurement 408 and the instrument measurement output 406 may be used to generate one or more calibration constants for adjusting the signal conditioning module 404. Calibration constants may, for example, include a zero off-set, a slope and zero off-set, or a multi-point piecewise linearization.

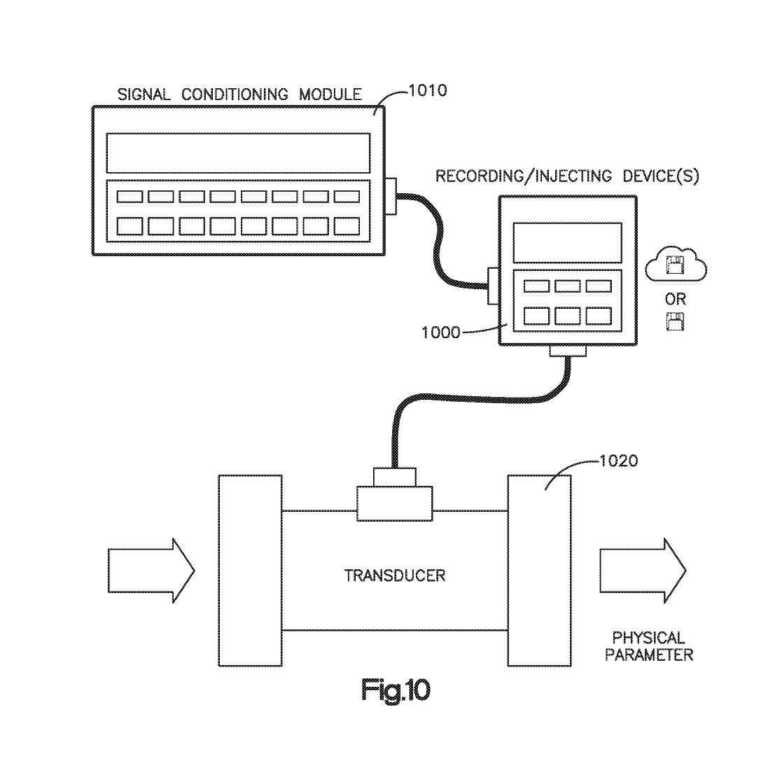

In embodiments, the calibrated data file 314 may be stored in a storage medium and loaded into the memory of a recalibration device, for example as described above with reference to FIG. 2. In other embodiments, however, the data file 314 may be stored and injected into the signal conditioning module 404 of the measurement instrument 302 using other mechanisms, for example as described below with reference to FIGS. 10-12.

The illustrated example shows the injection of a single recorded transducer signal (A) 402 and a comparison 410 of the resultant instrument measurement 406 with a single stored calibration measurement (X) 408. It should be understood, however, that other examples could include the injection of multiple recorded transducer signals (such as recorded transducer signals corresponding to a range of physical parameters that the instrument is designed to measure) and the comparison of the resultant instrument measurements 406 with multiple corresponding calibration measurements 408. In addition, other examples may include an adjustment to the instrument measurement 406 prior to comparison 410 with the calibrated measurement 408 to account for any known statistically quantified degradation of the transducer(s) in the measurement instrument 302 being recalibrated.

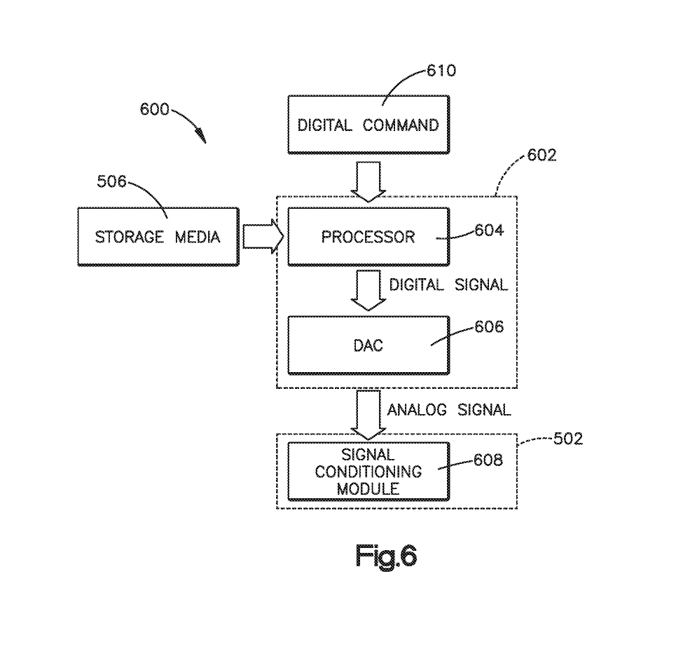

FIGS. 5 and 6 are block diagrams showing another example of a system for recalibrating a measurement instrument. FIG. 5 depicts an example system 500 for recording a transducer signal during an initial calibration. FIG. 6 depicts an example system 600 for using the recorded transducer signal to recalibrate the measurement instrument after it has been deployed in the field.

With reference first to FIG. 5, the illustrated system 500 includes a measurement instrument 502 under calibration, a recording device 504, and a storage medium 506. The measurement instrument 502 includes a transducer 508 and a signal conditioning module (not shown). The recording device 504 includes an analog-to-digital converter 510 and a processor 512.

The measurement instrument 502, as a complete unit, is subjected to a standard calibration by subjecting it to a full range of parameters 514 that the instrument is designed to measure while simultaneously recording its transducer signal, as well as the measurements 515 from a certified calibration standard(s) being subjected to the same parameters. During calibration, when the applied parameter 514 is deemed stable for calibration, the recording device 504 may be activated, for example using a digital command 516. The digital command 516 may, for example, be generated by a user interface device, an external software input, an internal software signal from the measurement instrument 502, or from another suitable source of digital commands. The command 516 instructs the processor 512 to initiate a recording sequence.

In the illustrated example, a recording sequence begins with the input command 516 being processed by the processor 512, which commences an analog-to-digital signal conversion using the analog-to-digital converter (ADC) 510. The analog-to-digital conversion may, for example, be initiated by the processor 512 sending a time synchronized digital command. The ADC 510 then begins converting the analog signal from the transducer 508 and returning a digital signal as a data stream to the processor 512 for timestamping and storage of the data stream. The ADC 510 samples and converts the transducer signal from an analog signal to a digital signal at a fixed sample rate and resolution, which may vary based on the requirements of the measurement instrument.

The processor 512 timestamps the received digital transducer signals and stores the digital transducer signals in the storage medium 506 in real time. As shown, the processor 512 may also receive measurements 515 from the certified calibration standard(s) and store the calibrated measurements in the storage medium 506 in relation to the corresponding transducer signals. The stored calibration data file may, for example, be identified by the starting time of the recording. The calibration data file may be archived after the recording sequence has ended, and represents the appropriate certified standard's reading derived for each data set recorded. The storage medium 506 may be a remote or local non-transitory storage medium. Examples of a remote storage medium 506 include an edge network storage and a cloud storage. A local storage medium 506 may, for example, include a variety of forms of digital storage devices.

The recording sequence ends when a digital command 516 is transmitted to the processor 512 to terminate the recording process. The processor 512 subsequently sends a digital command to the ADC 510 to stop further sampling and conversion, and the calibration data file is appropriately saved.

With reference now to FIG. 6, the illustrated system 600 includes a recalibration device 602, as well as the measurement instrument 502 and storage medium 506. The recalibration device 602 includes a processor 604 and a digital-to-analog converter 606. The measurement instrument 502 includes a signal conditioning module 608 and a transducer (not shown).

During recalibration, a measurement instrument 502 is typically subjected to the full range of parameters that the instrument is designed to measure. The stored calibration data 506 (recorded by the system of FIG. 5), however, enables periodic recalibrations to be performed without the need for a physical certified calibration standard or the need to generate the appropriate range of physical parameter(s). During this recalibration process 600, the recalibration device 602 is used to inject the previously recorded transducer signal from the storage medium 506 into the signal conditioning module 608, mimicking the transducer.

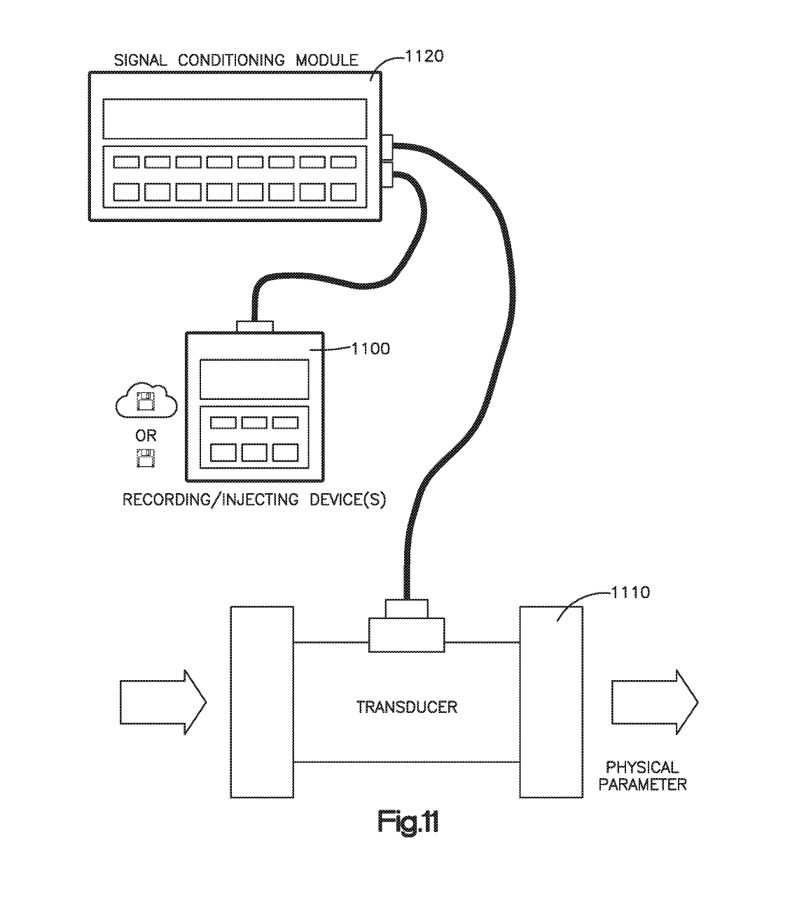

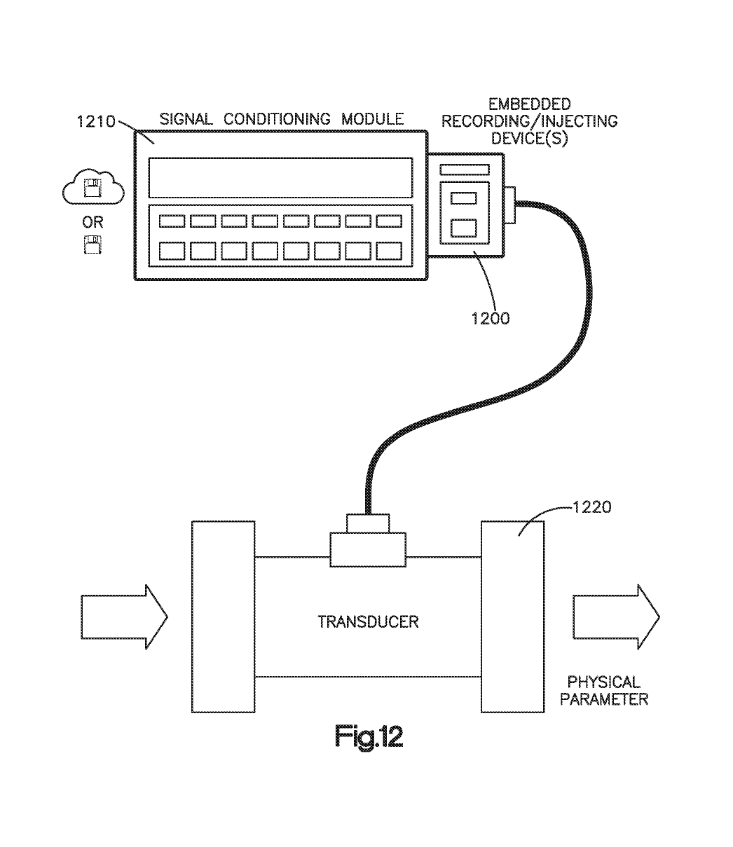

During recalibration, the measurement instrument 602 may be left in service, with the recalibration device 602 being used to inject the previously recorded data. In different embodiments, the recorded transducer signal may be injected into the measurement instrument 502 by connecting the recalibration device 602 to the signal conditioning module 608 in place of a disconnected transducer (e.g., as shown in FIG. 2), by connecting recalibration device 602 between the signal conditioning module 608 and the transducer (e.g., as shown in FIG. 10), by connecting the recalibration device 602 to an additional transducer input to the signal conditioning module 608 (e.g., as shown in FIG. 11), by utilizing a recalibration device 602 embedded within the measurement instrument 502 (e.g., as shown in FIG. 12), or by another suitable mechanism.

In the illustrated example, the injection of stored transducer signals by the recalibration device 602 is activated/deactivated using a digital command 610. The digital command 610 may for example, be generated by a user interface device (e.g., a touchscreen display or other user interface device on the recalibration device), an external software input, an internal software signal from the measurement instrument 502, or from another suitable source of digital commands. The digital command 610 instructs the processor 604 in initiate the signal injection sequence. In one embodiment, the recalibration procedure may be remotely actuated using a digital command 610 received through a wired or wireless connection to the recalibration device 602. During a remotely actuated recalibration, the stored calibration data 506 may, for example, be transmitted to the recalibration device from a remote storage location or may be retrieved by the recalibration device from a cloud or edge network storage location

The signal injection sequence begins with the processor 604 processing the digital command 610 and selecting a calibration data file from the storage medium 506 that represents the desired transducer signal. The processor 604 sends the calibration file data to the digital-to-analog converter (DAC) 606 for conversion into an analog signal. Instructed by the processor 604, the DAC 606 converts the calibration file data into an analog signal based on the included timestamp information, and injects the analog signal into the signal conditioning module 608. The analog signal may be generated at the same sample rate and resolution to avoid loss in signal integrity. The output of the signal conditioning module 608 is then compared against the stored certified calibration measurements for the given data set 506 in order to make any necessary calibration adjustments to the measurement instrument 502.

In certain embodiment, the components of the recording device 504 of FIG. 5 and the recalibration device 602 of FIG. 6 may be included in a single device, which may be used for both recording and recalibration. Other embodiments, however, may use difference devices for recording and for recalibration.

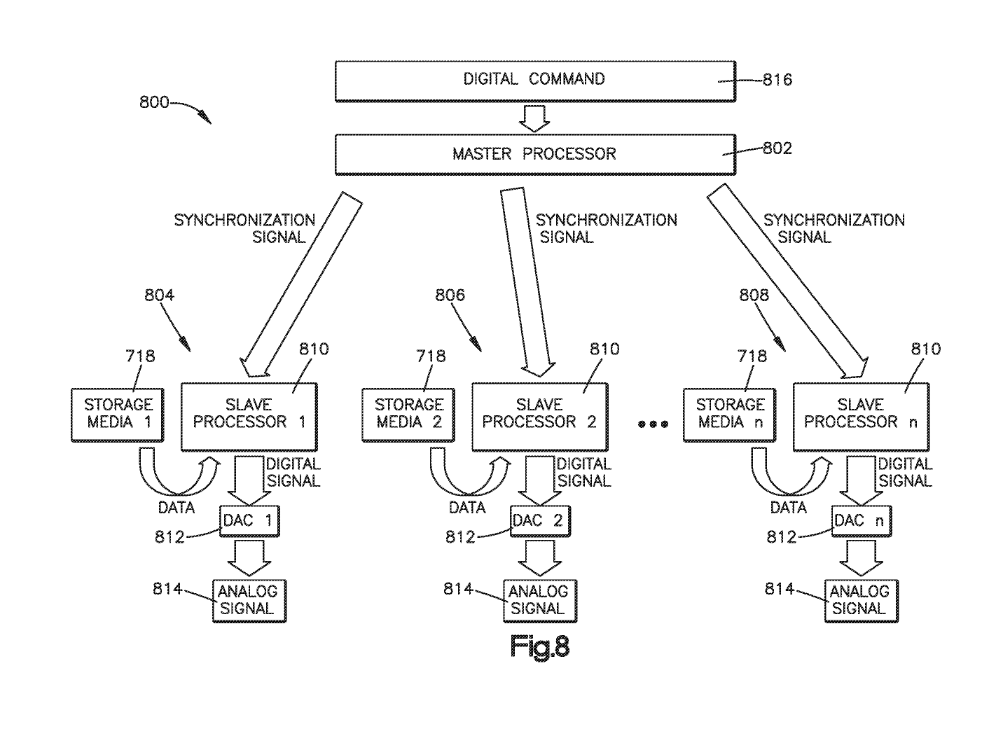

FIGS. 7 and 8 are block diagrams showing an additional example of a system for recalibrating a measurement instrument. The example recalibration system illustrated in FIGS. 7 and 8 is similar to the system depicted in FIGS. 5 and 6, but is modified to record and inject multiple simultaneous transducer signals. Specifically, FIG. 7 depicts an example system 700 for recording multiple simultaneous transducer signals during an initial calibration, and FIG. 8 depicts an example system 800 for using the multiple recorded transducer signals to recalibrate the measurement instrument after it has been deployed in the field.

With reference first to FIG. 7, the illustrated recording system 700 includes a master processor 702 that controls a plurality of recording sub-systems 704, 706, 708. Each recording sub-system 704, 706, 708 includes a slave processor 710 and an analog-to-digital convertor 712. Each recording sub-system 704, 706, 708 receives an analog transducer signal 714 from different ones of multiple transducers included in the measurement instrument under calibration. In other embodiments, multiple analog transducer signals 714 may be generated by a single transducer in a measurement instrument. For simplicity, the measurement instrument is not shown in FIG. 7.

As described above with reference to FIG. 5, the measurement instrument under calibration is subjected to a standard calibration by subjecting the measurement instrument and a certified calibration standard to a range of parameters. When the applied parameters are deemed stable for calibration, the recording system 700 may be activated by a digital command 716 that instructs the master processor 702 to start data recording. The digital command 716 may, for example, be generated by a user interface device, an external software input, an internal software signal from the measurement instrument, or from another suitable source of digital commands.

The master processor 702 transmits the start recording command to the slave processors 710 along with a reference clock time. The slave processors 710 then begin converting the received analog transducer signals 714 into digital transducer signals and storing the digital transducer signal data to a storage medium(s) 718 along with corresponding timestamp data, as described above with reference to FIG. 5. More specifically, the slave processors 710 initiate the analog-to-digital conversion, for example by sending time synchronized digital commands to the analog-to-digital converters 714. The ADCs 714 then convert the analog transducer signals 714 and return digital transducer signals as data streams to the slave processors 710. The slave processors 710 timestamp the received digital transducer signals and store them to the storage medium(s) 718 in real time. Although not shown in FIG. 7 for simplicity, the slave processors 710 may also receive measurements from the certified calibration standard(s) and store the calibrated measurements in the storage medium(s) 718 in relation to the corresponding transducer signals. The recording sequence ends when a digital command 716 is received by the master processor 702 and forwarded to the slave processors 710, which instruct the ADCs 712 to stop further sampling and conversion and save the calibration data file(s). The stored calibration file(s) may be identified by the starting time of the recordings and may be archived after the recording sequence has ended.

In different embodiments, the recording system 700 may store the calibration file(s) in a single or multiple data storage media 718. The storage media 718 may be remote or local non-transitory storage. Examples of remote storage media include edge network storage and cloud storage. Examples of local storage media may include a variety of forms of digital storage devices.

With reference now to FIG. 8, the illustrated recalibration system includes a master processor 802 that controls multiple recalibration sub-systems 804, 806, 808. Each recalibration sub-system 804, 806, 808 includes a slave processor 810 and a digital-to-analog convertor (DAC) 812. Each recalibration sub-system 804, 806, 808 is used to inject one of multiple recorded transducer signals into the signal conditioning module of the measurement instrument under recalibration, mimicking the instrument's transducers. The measurement instrument under recalibration is not shown in FIG. 8 for simplicity.

During recalibration, the measurement instrument may be left in service, with the recalibration system 800 being used to inject the previously recorded data into the signal conditioning module. The recorded transducer signals are injected into the measurement instrument by electrically connecting the analog output 814 of each recalibration sub-system 804, 806, 808 to multiple transducer inputs to the signal conditioning module. In an embodiment, the recalibration system outputs 814 may be connected to the signal conditioning module in place of disconnected transducers. In other embodiments, however, the recalibration system 800 may be included in a device that is connected between the measurement instruments transducers and signal conditioning module, or may be embedded within the measurement instrument.

In the illustrated example, the injection of stored transducer signals by the recalibration system 800 is activated/deactivated using a digital command 816 received by the master processor 802. The digital command 816 may, for example, be generated by a user interface, an external software input, an internal software signal from the measurement instrument, or from another suitable source of digital commands. To initiate recalibration, the master processor 802 receives the digital command 816 to commence data injection and transmits the command to the slave processors 810 along with a reference clock time.

The slave processors 810 select one or more calibration data files from the storage media 718 that represent the desired transducer signals. The slave processors 810 then initiate the digital-to-analog conversion, sending the stored digital transducer data to the DACs 812 for conversion into analog transducer signals 814. Instructed by the slave processors 810, the ADCs 812 convert the calibration file data into analog signals 814 based on the included timestamp information, and inject the analog signals 814 into the signal conditioning module (not shown). The transducer signal 814 output from each recalibration sub-system 804, 806, 808 is synchronized with the other slave processors 810 for simultaneous, synchronous injection into the signal conditioning module, to ensure that no phase shifts in signals are introduced due to timing errors.

The output of the signal conditioning module is then compared against the stored certified calibration measurements for the given data set in order to make any necessary calibration adjustments to the measurement instrument.

In embodiments, the components of the recording system 700 of FIG. 7 may be included in a single recording device, and the components of the recalibration system 800 of FIG. 8 may be included in a single recalibration device. In certain embodiments, the components of the recording system 700 of FIG. 7 and the recalibration system 800 of FIG. 8 may be included in a single device that is used for both recording and recalibration. It should also be understood that although three sub-systems are illustrated in the examples shown in FIGS. 7 and 8, other embodiments may include more or less sub-systems to accommodate measurement instruments with more or less transducers.

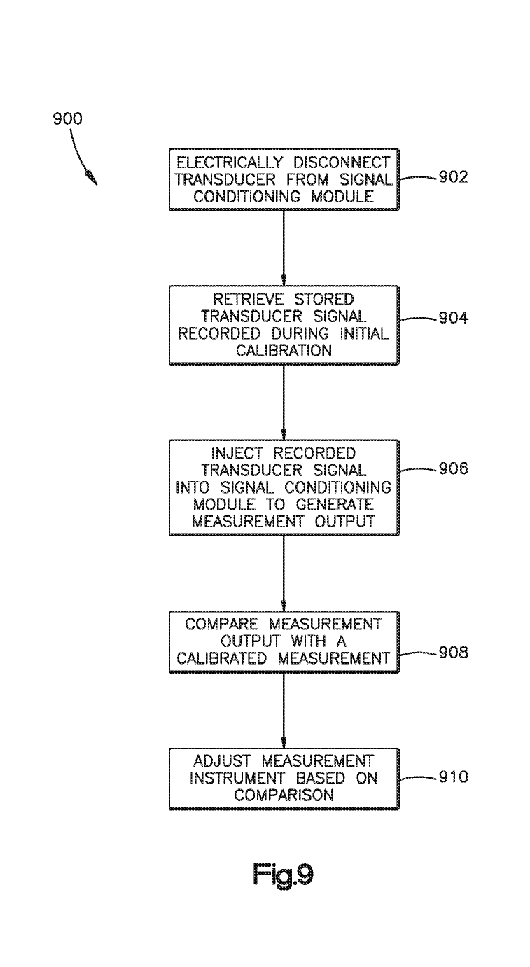

FIG. 9 is a flow diagram of an example method 900 for recalibrating a measurement instrument that includes a signal conditioning module and a transducer. The illustrated method 900 may, for example, be implemented using one or more of the systems described herein. At 902, the transducer of the measurement instrument is electrically disconnected from the signal conditioning module. At 904, a stored transducer signal is retrieved from a non-transitory storage medium, where the stored transducer signal is recorded during an initial calibration of the measurement instrument. At 906, the recorded transducer signal is injected into the signal conditioning module to generate a measurement output. At 908, the measurement output is compared with a calibrated measurement. At 910, one or more parameters of the measurement instrument are adjusted based on the comparison between the measurement output and the calibrated measurement.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents. For instance, FIGS. 10-12 illustrate examples of several different alternative embodiments.

FIG. 10 illustrates an example recalibration device 1000 that is connected between the signal conditioning module 1010 and transducer 1020 of a measurement instrument. In this example, the recalibration device 1000 includes switching circuitry (not shown) that is used to electrically disconnect the transducer 1020 from the signal conditioning module 1010 during a recalibration procedure, and inject recorded transducer signals into the signal conditioning module 1010 for recalibration using the methods described herein.

FIG. 11 illustrates an example embodiment in which the recalibration device 1100 and transducer 1110 are connected to different input ports of the signal conditioning module 1120 of a measurement instrument. In this example, the recalibration device 1100 includes switching circuitry (not shown) that is used to electrically isolate the transducer 1110 from the signal conditioning module 1120 during a recalibration procedure and inject recorded transducer signals into the signal conditioning module 1120 for recalibration using the methods described herein.

FIG. 12 illustrates an example embodiment in which the recalibration device 1200 is embedded within the signal conditioning module 1210 of the measurement instrument. Similar to the example shown in FIG. 10, this example recalibration device 1200 may include switching circuitry (not shown) that is used to electrically disconnect the transducer 1220 from the signal conditioning module 1210 during the recalibration procedure, and inject recorded transducer signals into the signal conditioning module 1210 for recalibration using the methods described herein. The recorded transducer signals may, for example, be stored in a memory device within the signal conditioning module 1210 or embedded recalibration device 1200, or may be stored remotely, for example using cloud or other network storage.

In certain embodiments, the example recalibration devices illustrated in FIGS. 10-12 may also be used for recording calibration data during the initial device calibration using the systems and method described herein.

It is claimed:

1. A method for recalibrating a measurement instrument that includes a transducer coupled to a signal conditioning module, comprising:
electrically disconnecting the transducer from the signal conditioning module;
retrieving a recorded transducer signal from a non-transitory storage medium, wherein the recorded transducer signal is stored to the non-transitory storage medium during an initial calibration of the measurement instrument;
injecting the recorded transducer signal into the signal conditioning module to generate a measurement output; and
comparing the measurement output with a calibrated measurement to determine if the measurement instrument is out of calibration.

2. The method of claim 1, wherein the calibrated measurement is stored in the non-transitory storage medium during the initial calibration of the measurement instrument.

3. The method of claim 2, wherein the calibrated measurement is generated by a certified calibrated standard during the initial calibration of the measurement instrument.

4. The method of claim 2, wherein the calibrated measurement is stored in a data structure in association with the recorded transducer signal.

5. The method of claim 1, further comprising:
electrically connecting a recalibration device to the signal conditioning module in place of the transducer, wherein the recalibration device is used for retrieving the recorded transducer signal from the non-transitory storage medium and injecting the recorded transducer signal into the signal conditioning module to generate the measurement output.

6. The method of claim 1, further comprising:
adjusting the signal conditioning module based on the comparison of the measurement output with the calibrated measurement.

7. The method of claim 1, further comprising:
determining a correction constant based at least in part on the measurement output and the calibrated measurement; and
using the correction constant to adjust one or more parameters of the signal conditioning module.

8. A device for recalibrating a measurement instrument that includes a transducer coupled to an input port of a signal conditioning module, comprising:
a processor configured to retrieve a recorded transducer signal from a non-transitory storage medium, wherein the recorded transducer signal is stored to the non-transitory storage medium during an initial calibration of the measurement instrument; and
an output port configured to be coupled to the input port of the signal conditioning module in place of the transducer,
the processor being further configured to cause the recorded transducer signal to be injected from the output port into the signal conditioning module, whereby the recorded transducer signal causes the signal conditioning module to generate a measurement output for use in recalibrating the measurement instrument with reference to a calibrated measurement.

9. The device of claim 8, wherein the output port is configured to be detachably coupled to the input port of the signal conditioning module.

10. The device of claim 8, wherein the device is permanently coupled between the transducer and the signal conditioning module and includes switching circuitry configured to electrically connect and disconnect the transducer to the input port of the signal conditioning module.

11. The device of claim 8, wherein the calibrated measurement is stored in the non-transitory storage medium during the initial calibration.

12. The device of claim 11, wherein the calibrated measurement is generated by a certified calibrated standard during the initial calibration of the measurement instrument.

13. The device of claim 11, wherein the calibrated measurement is stored in a data structure in association with the recorded transducer signal.

14. The device of claim 8, wherein the signal conditioning module is adjusted based on the comparison of the measurement output with the calibrated measurement.

15. The device of claim 8, wherein the processor is further configured to record the transducer signal during the initial calibration and store the recorded transducer signal to the non-transitory storage medium.

16. The device of claim 8, wherein the processor causes the recorded transducer signal to be injected from the output port into the signal conditioning module in response to a command received from a remote location via a wired or wireless network connection to the device.

17. A measurement instrument, comprising:
a transducer configured to generate a transducer signal in response to one or more physical parameters;
a signal conditioning module configured to convert the transducer signal into a format for display; and
a recalibration device coupled between the transducer and the signal conditioning module, the recalibration device configured to
electrically disconnect the transducer from the signal conditioning module,
retrieve a recorded transducer signal from a non-transitory storage medium, wherein the recorded transducer signal is stored to the non-transitory storage medium during an initial calibration of the measurement instrument, and
inject the recorded transducer signal into the signal conditioning module in place of the transducer signal to generate a measurement output.

18. The measurement instrument of claim 17, wherein the measurement output is compared with a calibrated measurement to determine if the measurement instrument is out of calibration.

19. The measurement device of claim 18, wherein the calibrated measurement is generated by a certified calibrated standard and stored to the non-transitory storage medium during the initial calibration of the measurement instrument.

20. The measurement instrument of claim 17, wherein the recalibration device is further configured to record the transducer signal during the initial calibration and store the recorded transducer signal to the non-transitory storage medium.
